(19) United States
(12) Patent Application Publication
(10) Pub. No.: US 2013/0268285 A1
(43) Pub. Date: Oct. 10, 2013

(54) MEDICAL DEVICE QUALITY CONTROL MANAGEMENT SOFTWARE

(71) Applicants: Steven J. Backes, Minneapolis, MN (US); Kevin A. Onken, Minneapolis, MN (US); Gary D. Manninen, Farmington, MN (US); Rania R. Johnson, Lakeville, MN (US)

(72) Inventors: Steven J. Backes, Minneapolis, MN (US); Kevin A. Onken, Minneapolis, MN (US); Gary D. Manninen, Farmington, MN (US); Rania R. Johnson, Lakeville, MN (US)

(21) Appl. No.: 13/440,611

(22) Filed: Apr. 5, 2012

(51) Int. Cl. G06Q 50/22; G06F 17/30; G06F 15/00

(52) U.S. Cl. 705/2; 702/183; 707/812

(57) ABSTRACT

Software is described to provide for mapping of a data file generated by a medical imaging device relating to quality control for the device to a format suitable for manipulation by a medical imaging device quality control management software. Various display interfaces can be provided to introduce certain functionalities, such as set up of the mapping function, reconciliation of the data association during the mapping process and the like. In this way, device specific software data can be integrated into effective management software that can extend across many different quality control test, potentially relating to a plurality of medical imaging devices and potentially across several locations.

### FIELD OF THE INVENTION

The invention relates to managing quality control for a plurality of medical diagnostic devices, including interface software to provide communication between a device specific quality control evaluation function associated with a medical diagnostic system with a quality control management system for medical diagnostic equipment. The invention further relates to electrical storage devices that stores the software, such as in non-volatile memory, and to electronic computing devices that execute the software to effectuate quality control integration and management for one or a plurality of medical diagnostic apparatuses.

### BACKGROUND OF THE INVENTION

Medical imaging provides an important dimension to providing health care, especially with respect to diagnosis and follow up. The proper maintenance of medical imaging devices is an important component of providing this service in a safe and effective manner. Cost constraints impose the necessity of providing the medical imaging and maintenance of medical imaging devices in an efficient manner. Government regulations as well as best practices established by physician and other medical professional groups can impose best practice guidelines and/or required quality control practices.

### SUMMARY OF THE INVENTION

In a first aspect, the invention pertains to a method for managing quality control for a plurality of medical imaging devices using a computer system comprising appropriate software and non-volatile memory, in which the method comprises receiving a data file relating to quality control test data for a medical imaging device, automatically identifying data from the received quality control test data and storing the identified data in non-volatile data storage comprising other medical imaging device quality control test data. Generally, the identified data comprises a unique identifier for the medical imaging device, identity of one or more quality control tests run on the medical imaging device, a date on which each of the one or more types of quality control tests were run, and test data corresponding to each of the one or more quality control tests run. Also, the invention can pertain to non-volatile computer memory devices storing the software and to methods for distributing the software to users.

In a further aspect, the invention pertains to a method for managing quality control for a plurality of medical imaging devices using a software program executed with a computer with access to suitable dynamic memory and non-volatile memory, in which the method comprises entering information through a display interface to establish a program to map quality control test data from a medical imaging device to a quality control worksheet format. The mapping can be performed such that the map provides for automatically identifying data from a quality control test data file generated by the medical imaging device, the identified data comprising a unique identifier for the medical imaging device, identity of one or more quality control tests run on the medical imaging device, a date on which each of the one or more types of quality control tests were run, and test data corresponding to each of the one or more quality control tests run. The invention can also pertain to computer memory devices storing this software as well as methods of distributing this software to users.

In another aspect, the invention pertains to a quality control system for managing the quality control of a plurality of medical imaging devices comprising:

a first software module on a non-volatile memory device accessible by a computer integrated with a medical imaging device to control the operation of the medical imaging device and at least one quality control operations of the medical imaging device; and

a second software module on a non-volatile memory device accessible by a networked computer configured to receive test data from a plurality of medical imaging devices each associated with a first software module, wherein the second software module generates a report based on the test data from the first software module. The invention can similarly pertain to method for distributing medical imaging quality control software, in which the method comprises facilitating the establishment of the quality control system by distributing software to a non-volatile, computer readable memory device corresponding to the second software module above to a customer having access to data files from the first software module. In addition, the invention can also pertain to a method for establishing a medical imaging quality control system comprising programming a second software module as described above specifically to interface with a first software module described above and storing the second software module on a non-volatile computer readable memory device.

In other aspects, the invention pertains to a management system for medical device quality control, including hierarchical dashboards that can be used to monitor the status of important quality control processes, including device quality control, professional and facility credentials, and dose information. The hierarchical dashboards can be used to manage diagnostic equipment operations across even complex healthcare organizations, with visual cues to indicate status, and drill-down capabilities to isolate and research quality control issues, enabling medical physicists, radiation safety managers and other interested parties to manage enterprise quality control.

### BRIEF DESCRIPTION OF THE DRAWINGS

FIG. 1 is a block diagram of an exemplary quality control architecture that can be used to implement the quality control software components.

FIG. 2A is a flow chart of an embodiment of the quality control interface processing process.

FIG. 2B is a screen shot of a GUI generated by quality control software specific to a CT scanner.

FIG. 3 is a screen shot of a GUI generated by the quality control interface processing software; the GUI is configured to receive user supplied additional information.

FIG. 4 displays the contents of an embodiment of a quality control data file in XML file format produced by quality control software specific to a CT scanner, the quality control data file comprising results obtained from a phantom image analysis.

FIG. 5 is a screen shot of a GUI generated by the quality control interface processing software used to set-up a quality control interface processing map, the GUI configured to receive mapping information comprising information related to the location and type of quality control test run.

FIG. 6 is a screen shot of a GUI generated by the quality control interface processing software used to set-up a quality control interface processing map, the GUI configured to receive mapping information comprising information related to parameters and results of quality control a test.

FIG. 7 is a screen shot of a quality control test plan set-up GUI generated by the quality control management software.

FIG. 8 is a screen shot of a quality control worksheet set-up GUI generated by the quality control management software.

FIG. 9 is a screen shot of a quality control dashboard GUI generated by the quality control management software.

FIG. 10 is a screen shot of a 5 Day Average Report generated by the quality control management software.

FIG. 11 is a daily, weekly, and bi-weekly quality control report generated for a medical imaging device by the quality control management software.

### DETAILED DESCRIPTION OF THE INVENTION

Interface software is described to provide a connection between quality control management software for medical diagnostic devices and software obtaining results on a specific medical imaging device or a quality control evaluation. Using the interface software, data and evaluation information from the quality control test can be automatically entered into the quality control management system so that the particular quality control measurements can be integrated under the available functionality of the management software. Medical imaging devices generally are maintained using one or more quality control checks that may be performed at desired times in the life cycle of the device. For medical imaging devices, a range of quality control tests are generally performed, and the time frame for the tests can range from multiple time per day to weekly, monthly or yearly. The results of the tests are generally required to be maintained for the device under U.S. statute, guidelines specified by formal regulations, such as regulations promulgated by the U.S. Food and Drug Administration and/or other U.S. Administrative Agencies, State legislatures and health departments, and recognized accrediting bodies such as the American College of Radiology, the Joint Commission and the American Association of Physicists in Medicine (“AAPM”). Quality control management software can facilitate the maintenance of records and the production of reports for a plurality of medical diagnostic devices and/or a plurality of different quality control tests for a specific device to provide a dramatic simplification of the quality control management process. Some specific quality control tests can involve relatively complicated data analysis with specialized software to perform the analysis. The ability to integrate the evaluation of the quality control data performed by device specific software with the quality control management software provides considerable improvement in the quality control process along with significant reduction of effort while providing the potential for improving the rigor of the quality control process.

The quality control architecture can be designed to facilitate the process of quality control management across many medical imaging devices within a medical imaging facility or distributed across many imaging facilities and/or independent locations. In some of the embodiments described herein, the quality control architecture comprises three software components: (1) the quality control management software, (2) the medical imaging device quality control software and (3) the quality control interface processing software. The quality control interface processing software facilitates the communication of data obtained by running a quality control test on a medical imaging device between the medical imaging device quality control software and the quality control management software.

The quality control management software centrally manages quality control data, which can comprise a plurality of different quality control tests results relating to a plurality of medical imaging devices. The quality control management software can include various components to capture and record quality control data, schedule quality control tests, and/or create reports or collections of reports for audits and on-going monitoring. In some embodiments, the quality control management software can also have data management workflows for maintaining and tracking data related to the quality control process, including, for example, clinical professional and facility credential records, medical device maintenance records, medical device procedure guides, service records, lead shielding tracking data, medical physicist reports, medical device performance data, dose data, and other data related to the quality control process.

The quality control management software can configure quality control test plans for one or more of the medical imaging devices being managed. The quality control test plan can comprise one or more quality control tests that are to be run on a specific medical imaging device at a specific medical imaging facility. The quality control test plan can further specify a schedule for running a specific quality control test on a specific medical imaging device. Quality control data obtained by running a quality control test on a specific medical imaging device can then be collected by the quality control management software and stored as native quality control data files. The stored quality control data files can then be used by the quality control management software to generate reports to assess the status of medical imaging devices and/or facilities, monitor compliance with regulatory and facility performance standards, and provide compliance information to auditors and inspectors. The stored quality control data files can also be used by the quality control management software to generate a hierarchical dashboard display that shows quality monitoring information, such as the status of imaging units in the organization or dose levels being delivered by imaging units, and allows the user to drill down to specific imaging facilities or imaging device and further analyze the performance condition.

To provide a specific convenient format for the quality control management, the quality control management software can collect quality control test data in worksheets, specific to a type of medical imaging device and specific to a type of quality control test. A worksheet is an instance of a worksheet template, which describes a format of the data file. The worksheet template generally can contain information identifying which quality control test data elements are required for entry by the user and which ones are optional, the sequence of the data entry process, user prompts to be displayed for each test data element, and calculations to be performed on data elements. A worksheet template can be defined for each type of vendor and model (“Vendor/Model”) combination for the medical imaging device. For each type of quality control test to be performed on a specific Vendor/Model combination, the worksheet template indicates quality control data that is to be recorded in the worksheet template after running the quality control test. An updated version of the worksheet template can be created if there are changes in the quality control data needs for the Vendor/Model. The appropriate version of the worksheet template can be applied to all medical imaging devices being managed having the specific Vendor/Model combination. At an appropriate time the worksheet template is populated with appropriate information to form a completed or partially completed worksheet. Below, a specific discussion is provided in the context of a powerful commercially available quality control management software, QC-Track®.

In some embodiments, the worksheets can be completed manually. In such embodiments, the quality control management software can display to a user a graphical representation of the worksheet containing empty data fields. The user can then enter quality control data obtained by running a quality control test on a medical imaging device into the empty data fields to complete the worksheet template. The completed instance of the worksheet can then be saved as a worksheet data file containing the quality control data entered by the user.

In other embodiments, quality control interface processing software can significantly facilitate the process of completing worksheets for at least certain quality control tests by taking quality control data files containing quality control data produced by a medical imaging device specific software, whether operating on the medical imaging device or as a separate free-standing software, and automatically complete worksheet templates or a portion thereof. The quality control interface processing software can function as an interface for importing quality control data files into the quality control management software. As used herein, importing quality control data refers to the quality control interface processing software receiving quality control data from a quality control data file or stream, mapping the received quality control data to a format readable by the quality control management software, and either writing the formatted quality control data to a data file and/or passing the formatted quality control data to the quality control management software, as explained in detail below. While the specific type of quality control data that can be imported can be selected as desired, the quality control interface processing software can import quality control data produced by medical imaging devices that emit ionizing radiation, such as digital radiography (“DR”), computed tomography (“CT”), single-photon emission computed tomography (SPECT), and full field digital mammography (“FFDM”) medical imaging devices and/or medical imaging devices that use other forms of sense energy for imaging, such as magnetic resonance imaging (“MRI”), positron emission tomography (“PET”), nuclear medicine, and ultrasound systems, as well as combinations thereof, such as PET/CT systems. The quality control data can be generated by the device itself, or by a software package, such as a phantom image QC product or an optical character recognition (“OCR”) process, that is designed to analyze and evaluate test image data captured from the imaging device. Additionally, the quality control interface processing software can also import quality control data from imaging systems used in cardiology, orthopedics, radiation oncology, neurology and dentistry. Similarly, other types of devices and processes related to radiation safety and device quality control can generate data in a format that can be processed and imported by the quality control interface processing software into the quality control management software. Such radiation safety processes that may generate data include, but are not limited to, lead apron/shielding monitoring, device dosimetry, medical physicist annual tests, commissioning and calibration tests, patient dosage monitoring, and QC processes for image printers, digitizers, and desktop and portable image viewing workstations. Similarly, software can capture qualitative or metric quality control data manually entered by the operator of the imaging device, and entered either from the device console or a separate workstation, format the data, and transmit the data to the quality control interface processing.

Generally, a medical imaging device specific software outputs quality control data in a format native to the specific software and, generally, not formatted for processing by other software such as the quality control management software. Possibly with modest formatting harmonization of the data file from the device specific quality control software, the software components can be integrated. The quality control interface processing software can have the ability to locate within a quality control data file produced by a medical imaging device software, data required to complete a worksheet template or a portion thereof. This ability for importing the data output of a quality control software program into a quality control management program can significantly increase the ease and efficiency of managing quality control for numerous medical imaging devices. Radia Diagnostic and Radia Therapy are two medical imaging device specific software solutions currently available from Radiological Imaging Technology, Inc. (Colorado Springs, Colo.). Radia Diagnostic and Radia Therapy allow for quality control phantom imaging analysis for a variety of medical imaging devices. The quality control data generated by the Radia software solutions can be imported by the quality control interface processing software into the quality control management software to facility quality control management of medical imaging devices, as discussed in detail further below.

The quality control data files produced by the medical device specific software can comprise quality control data obtained by running a quality control test on the medical device. The data may or may not involve further analysis of the output data from the medical imaging device. The quality control test data file can comprise quality control data types including, for example, a medical imaging device identification (“ID”), a facility ID, a user ID, quality control test ID, status ID, imaging device type, image type, and/or test metric data. The medical imaging device ID and the facility ID can identify the particular medical imaging device on which the quality control test was run and in which imaging facility, and the user ID can identify the person who physically executed the quality control test on the medical imaging device. The quality control test ID can identify what type of quality control test was run (e.g. phantom image), and the status ID can identify the outcome of the quality control test (e.g. pass or fail). The imaging device type and image type can identify the type of medical imaging device (CT, MRI, FFDM . . . etc.), and the image type can indentify what type of image, if any, was used to generate the quality control test data. The test metric data corresponds to data generated during the quality control tests. The test metric data can include, for example, information about the what observables were directly measured, results of analyses performed by the medical device specific software on the observables, operating parameters of the medical imaging device during the quality control test, and/or specific parameters of the quality control test (e.g. the configuration of a sample in the medical imaging device). In some embodiments, the quality control test data can optionally comprise comments entered by a person who ran the quality control test to provide an added dimension to the numerical data.

In some embodiments, it is desirable for the medical device specific software to store quality control data as a structured data file. Examples of structured data files include, for example, extensible markup language (“XML”) files, portable document format (“PDF”) files, or comma-separated value (“CSV”) file. Tags associated with structured data file formats greatly improve processing efficiency of the quality control data files by the quality control interface processing software. In structured data files such as XML data files, the processing efficiency of the quality control data files by the quality control interface processing software is further improved because the tags capture the meaning of the tagged terms. Two specific examples of quality control data files in XML format are described below.

In general, the quality control interface processing software can be designed to identify quality control test data distributed in a variety of ways across data files. In some embodiments, the quality control data for a single quality control test is stored in a single quality control data file. In some embodiments, the quality control data for a single quality control test is stored in multiple quality control data files. For example, in one embodiment, it can be desirable to store comments in one quality control data file and the remainder of the quality control data in a separate data file. In some embodiments, the quality control data for multiple quality control tests can be stored in a single file. For example, in one embodiment, a plurality of quality control data files can be merged into a single file, for example, a single compressed file such as a .zip file. The quality control interface processing software's ability to read quality control data from quality control data files can be very versatile with respect to data file structure. Thus the ability to integrate the quality control management software with device specific quality control evaluation software provides a significant added dimension to the functionality and efficiency to the great simplification and convenience available from the quality control management software.

### Quality Control Architecture

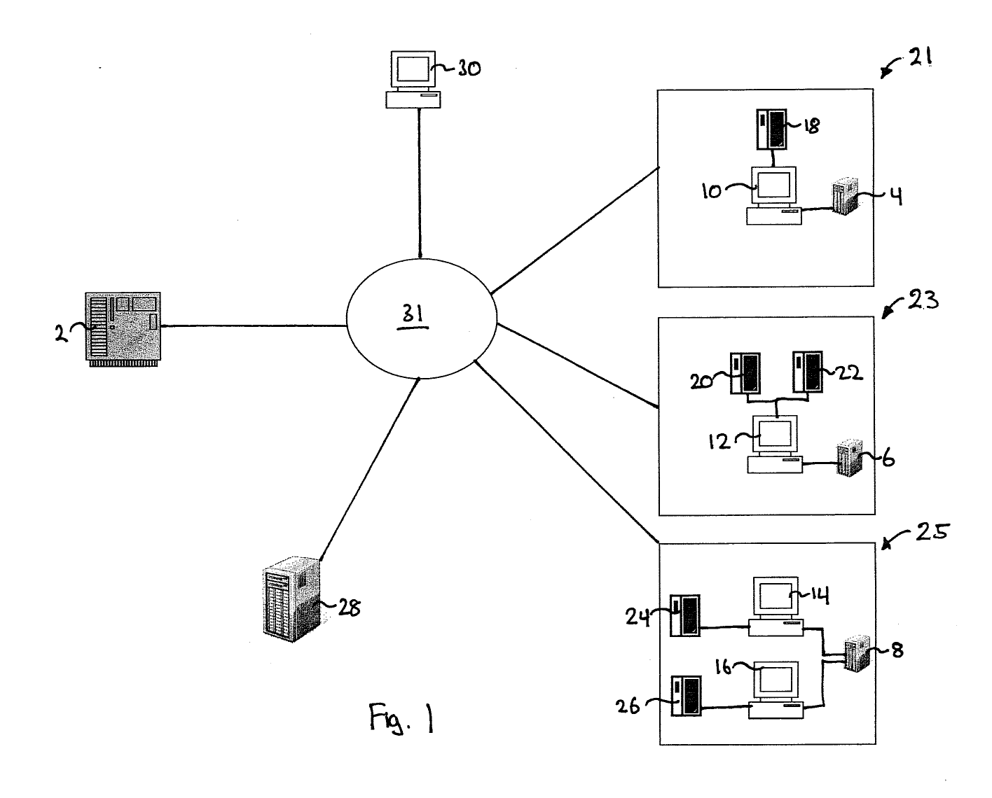

The quality control management architecture can be distributed in many ways across hardware components and is not particularly limited by any specific distribution. FIG. 1 is a logical representation of the quality control architecture. The quality control management software and quality control interface processing software can be stored on computing device 2. However, in other embodiments, the quality control management software and quality control interface processing software can be stored on different computing devices. In this representative embodiment, medical device specific imaging software can be stored on storage devices 4, 6, 8 and is executed by computing devices 10, 12, 14, 16. Quality control test data generated by running quality control tests on the medical imaging devices 18, 20, 22, 24, 26 at different medical imaging facilities 21, 23, 25 can be stored on storage devices 4, 6, 8, respectively, which can be accessible to computing device 2, for example, through an appropriate wired or wireless network. Additionally and/or alternatively, the quality control test data generated can be stored on storage device 28, accessible directly and/or following physical movement of the storage device for a portable storage device to computing device 2 and/or by some or all of the computing devices 10, 12, 16. The quality control data can be stored in a format that can be processed by the medical device specific software, the quality control management software, and/or as a Digital Imaging and Communications in Medicine (“DICOM”) image as part of a Picture Archive and Communications System (“PACS”) system stored on storage device 28 or other storage device. A person of ordinary skill in the art will readily know how to distribute the software components over other architecture layouts based on the teachings herein.

In some embodiments, some or all of the software components can be transferred to a storage device (or storage devices) of the quality control management architecture, for example the storage devices depicted in FIG. 1, from software storage media delivered to a customer. The software storage media can comprise, for example, CD; DVD; Blu-Ray Disc; floppy disk; hard drive; solid state drive; flash memory storage such as Compact Flash, Secure Digital, and Memory Stick type storage devices; or any other form of storage media capable of allowing at least some of the software stored thereon to be transferred to a storage device. In additional or alternative embodiments, some or all of the software components can be transferred to a storage device (or storage devices) of the quality control management software by digital download from another storage device that may or may not be a component of the quality control management architecture. A person of ordinary skill in the art will recognize that transferring a software component can include transferring a portion thereof.

Computing devices refer to devices with a processor, memory (e.g. volatile storage) and accessible non-volatile storage. The computing devices can comprise, for example, personal computers, server computers, computing tablets, set top boxes, mobile telephones, cellular telephones, personal digital assistants (“PDAs”), portable computers, notebook computers, RF readers, barcode readers, light meters, laptop computers or any variations thereof now in use or developed in the future. Computing devices may run an operating system, including, for example, variations of the Linux, Unix, Microsoft Disk Operating System (“MS-DOS”), Microsoft Windows, Palm OS, Symbian, Android OS, Apple Mac OS, and/or Apple iOS operating systems. In general, the computing device may be coupled with a display. For convenience, display representations can be referred to as a graphical user interface or GUI, but in general this is intended to refer to traditional GUI formats, three dimensional display representations and/or future developed display formats as well as variations thereof.

The hardware components of the quality control system architecture (e.g. the computing devices and/or the medical imaging devices) can be interconnected through network 31. For example, network 31 can be a wired or wireless interne connection, a wired or wireless intranet connection or any suitable communication channel. The various hardware components of the quality control system architecture can be interfaced through network 31 to allow for intercommunication of the hardware components across facilities and/or within a facility. In one embodiment, the medical imaging facilities 21, 23, 25 are located in different geographical locations from each other and/or from computing device 2. For example, medical imaging facilities 21, 23, 25 may be located in different cities, different states, and/or different countries. Interconnectivity of the hardware components through network 31 allow the quality control management software stored on computing device 2 to manage the quality control of the medical imaging devices that may be geographically separated.

Users can, in general, access the various quality control software components from a variety of access points based on a particular network. In one embodiment, a user can remotely execute the quality control management software and/or quality control interface processing software on storage device 28, for example, from computing device 2, computing device 30 and/or computing devices 10, 12, 14, 16, located at different medical imaging facilities 21, 23, 24. Multiple instances of the quality control interface processing software can be simultaneously run, which allows for multiple users, for example at different computing devices, to simultaneously import data into the quality control management software. In some embodiments, access and login to the quality control management software and/or the quality control interface processing software may be performed through a user interface via a web browser based on appropriate security measures. In some embodiments, when a username, password and/or crypto key number are authenticated by the quality control management and/or connector software, an appropriate screen can be displayed based on the user's predefined role.

Users of the system may include a variety of individuals such as radiologists, quality control technologists, radiology technologists, medical physicists, other users involved in radiation safety and quality control in medical imaging, biomedical engineers, administrators, referring physicians, clerical and other facility employees, field service technicians, vendor support staff, compliance inspectors, and information technology (“IT”) support staff. As illustrated above, various system architectures are envisioned for the quality control system, and the various system users may access the various software components from a variety of resources and locations with an appropriate level of access for the individual. For example, a technologist may interact with the system via system interfaces provided at any number of computing devices located within a medical imaging facility, whereas users involved in radiation safety and quality control in medical imaging may interact with the software components via a network-connected computing device located remotely from medical imaging facilities. The architecture flexibility allows for accommodating any desirable configuration of such access points to the software components.

Furthermore, in some embodiments it can be desirable to limit access to certain software components, or parts of software components, to specific types of users. For example, clerical users might only need to maintain user credentials and generally do not need access to any parts of the medical imaging device specific software or the quality control interface processing software and, therefore, can be restricted from those software components and workflows. Similarly, users other than IT support staff and medical physicists may not need access to the quality control interface processing set-up functionality of the quality control interface processing software (described below) and therefore, can have access to the quality control interface processing software that allows them limited access privileges having only the ability to execute the quality control interface processing software.

### Quality Control Interface

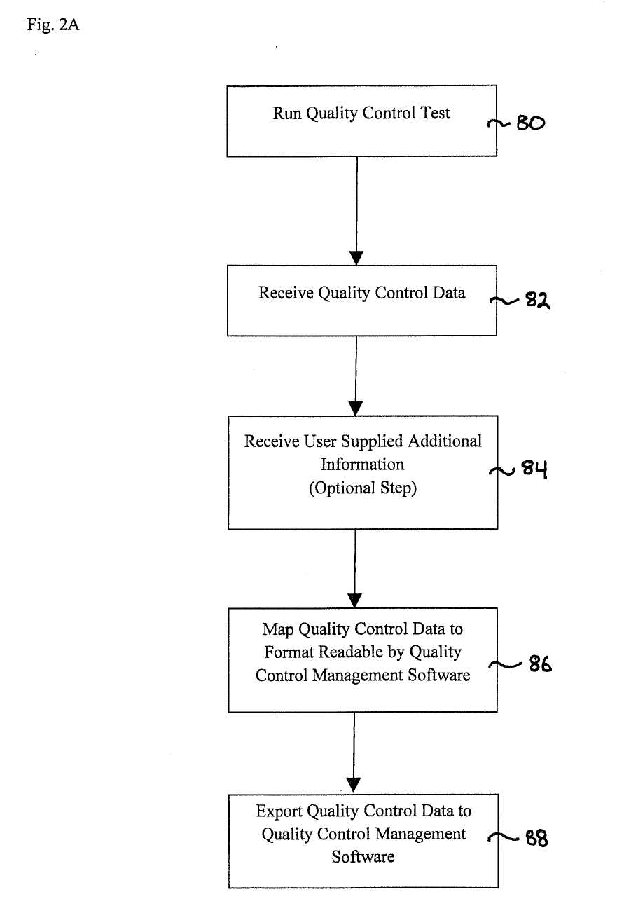

The quality control interface processing software maps data from the quality control data files produce by the medical imaging specific software into the quality control management software. FIG. 2A is a flow chart representation of an embodiment of the quality control interface processing functionality within an embodiment of the quality control management process. A quality control test is performed on a medical imaging device at step 80. At step 82, the quality control interface processing software receives quality control data obtained by running the quality control test on the medical imaging device at step 80. During or after receiving some or all of the quality control data, the quality control interface processing software maps the received quality control data to place it in a format readable by the quality control management software at step 86. In some embodiments, a user can supply additional information to the quality control interface processing software at step 84 to reconcile the received quality control data elements with information expected from the quality control management software such as, for example, a worksheet template. At step 88, the quality control interface processing software can write the mapped quality control a data to a quality control data file readable by the quality control management software and/or pass it to the quality control management software without writing a data file. The quality control interface processing software can provide a digital interface to assist in a user setting up the mapping operation.

Quality control data can be received by the quality control interface processing software using a variety of methods. In some embodiments, the quality control interface processing software is provided the location or locations of quality control data files and the quality control interface processing software can read the quality control data from the quality control data files at the provided location. In such embodiments, the locations of the quality control data can be provided by a user and/or the medical imaging device specific software. In some embodiments, the quality control interface processing software is provided the location of a data stream comprising quality control data. In such embodiments, the medical device specific software can provide the quality control interface processing with the location of a data stream and/or the quality control management software can be configured to listen for data stream on a port or ports such that directing a data stream or streams to the port or ports automatically begins processing of the quality control data therein. The source of the data stream can be a quality control data file written to a storage device or can be quality control data resident in the volatile memory of a computing device. For example, quality control data stored in a computing device's volatile memory by medical imaging device specific software can be directly streamed to the quality control management software without writing the quality control data to a storage device.

In one embodiment in which the quality control interface processing software is passed the location of a data stream, the medical imaging device specific software can provide the location of the data stream to the quality control interface processing software, as shown in FIG. 2B. FIG. 2B is a screen shot of a display interface, such as a graphical user interface (“GUI”), generated by quality control software specific to a CT scanner. GUI 32 displays a phantom image analysis results (i.e. quality control results) obtained from a CT scanner. Included in the displayed test results is information specifying the institution 34 (e.g. imaging facility), and the device 36 within the institution upon which the phantom image quality control test was run. For this embodiment, clicking icon 38 causes the quality control software specific to the CT scanner to save the results of the phantom image analysis to data file(s) and causes the quality control management software to execute (or to be brought to the foreground if the software is already executing). If the user clicking icon 38 is not already logged into the quality control management software, the user can be prompted to login. The location of the saved imaging phantom analysis quality control data is passed to the quality control management software and, ultimately to the quality control interface processing software. In other embodiments, as described above, the medical device imaging software can provide the quality control data to the quality control management software without writing the quality control data to a storage device.

Once some or all of the quality control data is received, the quality control interface processing software can optionally allow a user to supply supplementary information to aid in reconciling the received quality control data with data expected by the quality control management software. In one embodiment, data expected by the quality control management software is represented by a worksheet template configured to receive quality control test data from a quality control test run on a medical imaging device, as explained above. In such an embodiment reconciling can comprise selecting the appropriate worksheet template corresponding to the received quality control data.

For example, the received quality control data may contain a device facility ID, device ID and/or QC test ID that is different from the IDs used by the quality control management software. In such an instance, the user can be asked to provide, for the facility ID, device ID and/or quality control test ID contained in the received quality control data, a corresponding ID used by quality control management software. Once the corresponding quality control management software are identified, the quality control interface processing software can select the appropriate worksheet template corresponding the received quality control data. Clearly, if the quality control data file uses facility IDs, device IDs and/or QC test IDs also used by the quality control management software, user supplied reconciliation information in this context can be avoided.

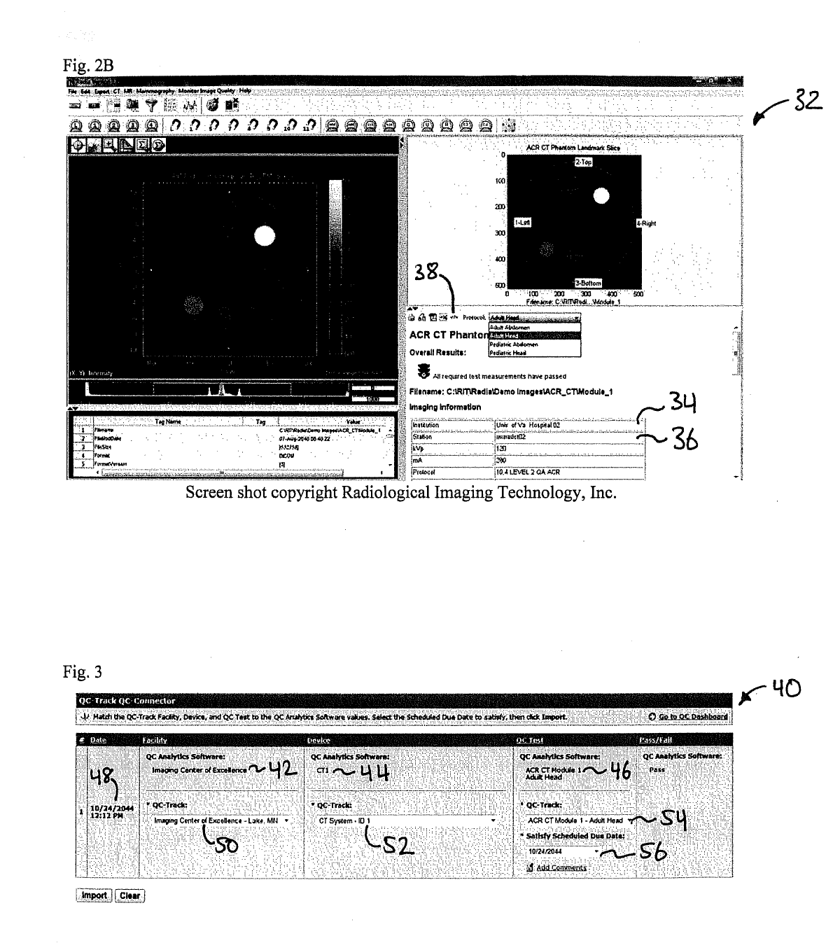

Additionally or alternatively, reconciliation can comprise requesting a user to specify or to verify the due date of the quality control test corresponding to the received quality control data. As explained above, the quality control management software can define a schedule for running specific quality control tests on specific medical imaging device. The schedule specifies a specific due date or dates for running a quality control test on a medical imaging device. If the received quality control data corresponds to a scheduled quality control test, the user can be asked to specify or to verify what due date the received quality control data is intended to satisfy. Whether the received quality control test data corresponds to a scheduled test within the quality control management system can be determined, for example, from the facility ID, device ID, and/or quality control test ID contained in the quality control data file or supplied by the user as described above. If it is determined that that received quality control test data corresponds to a scheduled quality control test, the user can be presented with a list or partial list of past, present or future due dates and can be asked to select a date that corresponds to the quality control data received. If there is already quality control test data entered in satisfaction of the user selected due date, the quality control interface processing software indicates this to the user and may provide the user the option of overwriting previously stored quality control data associated with the specified due date. If the quality control data received is not associated with a specific due date, the user can nevertheless store the quality control test data in a format accessible by the quality control test management software. Such non-scheduled quality control test data can be desirable for recalibrating the corresponding medical imaging device after a medical physicist test, after an unscheduled service call relating the medical imaging device or as part of a scheduled preventative maintenance call. One embodiment of a user supplied information process is depicted in FIG. 3. FIG. 3 is a screen shot of a GUI generated by the quality control interface processing software. The GUI 40 displays information contained in the quality control data file comprising quality control data corresponding to a single quality control test. In particular, GUI 40 displays facility ID 42, device ID 44, QC Test ID 46 and date 48 the corresponding quality control test was run. In this embodiment, because facility ID 42, device ID 44, QC Test ID 46 are not the same IDs used by the quality control management software, the user is requested to provide corresponding facility ID 50, device ID 52, and QC Test ID 54 used by the quality control management software. Additionally, because, from facility ID 50, medical imaging device ID 52, quality control test ID 54, the quality control interface processing software can automatically determine the imported quality control data corresponds to a scheduled quality control test, drop-down list 56 is presented and the user is asked to select a due date among a set of due dates. If the quality control test data being imported is not associated with a scheduled quality control test, the user can select “none” from the dropdown list and the quality control test data can nevertheless be imported in the quality control management software. In the embodiment depicted in 3, the quality control data file comprises quality control test data for a single quality control test. However, in embodiments where the quality control data file comprises quality control data for a plurality of quality control tests, each quality control test would be displayed by GUI 40 either sequentially or simultaneously.

After receiving quality control data and/or optional supplemental user supplied information, the quality control interface processing software can map the quality control data. Mapping comprises placing the received quality control data in a format readable by the quality control interface processing software. As described above, a worksheet template or worksheet data file can represent a format readable by the quality control interface processing software. In one embodiment, the quality control interface processing software can map the received quality control data and write a worksheet data file. Additionally, or alternatively, the quality control interface processing software can pass the mapped quality control data to the quality control management software by storing the mapped quality control data in volatile memory readable by the quality control management software. Additionally, or alternatively, the quality control interface processing software can pass the mapped quality control data to the quality control management software by transmitting the mapped quality control data via a direct cable connection, such as an RS-232 or USB cable, to the quality control management software. Additionally, or alternatively, the quality control data can be transmitted via a network in a standard medical industry format such as HL7 or as part of a DICOM header. In some embodiments, the quality control interface processing software can populate some or all of a worksheet template data fields represented in a GUI so that a user can confirm the accuracy of the mapping prior to writing a worksheet data file and/or passing the quality control data to the quality control management software.

In some embodiments, the quality control interface processing software can use a quality control interface processing map to import the quality control data file to the quality control management software. The quality control interface processing map can identify the location of particular quality control data in the received quality control data. For example, if for a specific quality control test, the quality control management software expects the date the specific quality control test was run, the quality control interface processing map can identify the location of the date within the received quality control data from the quality control data file and supply that information to the quality control management software. In general, a quality control interface processing map can be set-up for each combination of quality control management software expected format and quality control data file format. In some embodiments, the format of the data expected by the quality control management system can be in the form of a worksheet template, as described above. In such an embodiment, a quality control interface processing map can be specified for each combination of worksheet template and format of the quality control data to be received by the quality control interface processing software. Additionally or alternatively, if the format of the quality control data to be received is unique to a particular Vendor/Model combination of a medical imaging device, a quality control interface processing map can be setup for each combination of worksheet template and medical device Vendor/Model combination. The quality control interface processing software can use the maps to populate the worksheet fields, which can be saved as a worksheet data file comprising the mapped quality control data by the quality control management software and/or by the quality control interface processing software, along with versioning information. Versioning information comprises version of the quality control test run on the medical imaging device corresponding to the quality control data imported. Versioning information can be particularly useful were quality control test are changed, for example, to conform with updated regulatory requirements. In addition a message can be posted to and audit log that indicates a worksheet record has been written. The quality control interface processing map can be set-up (i.e. created or modified) within the quality control management software, within the quality control interface processing software and/or within the software specific to a medical imaging device. The maps are generally stored on a non-volatile storage medium accessible by the quality control interface processing software. The maps can be stored in separate data files or can be combined into a single data file.

In embodiments where the quality control data file is imported into the quality control management software is received from a structured data file, the quality control interface processing map can comprise a collection of quality control data types and a collection of tags, used to locate quality control data corresponding the quality control data types in the received quality control data. In such an embodiment, when the quality control interface processing software is requested to import quality control data into the quality control management software, the quality control interface processing software can obtain from the quality control management software specific data types to import and the quality control interface processing software can access the map to obtain the corresponding tags. The quality control interface processing software then uses the tags to locate the specific data types expected by the quality control management software.

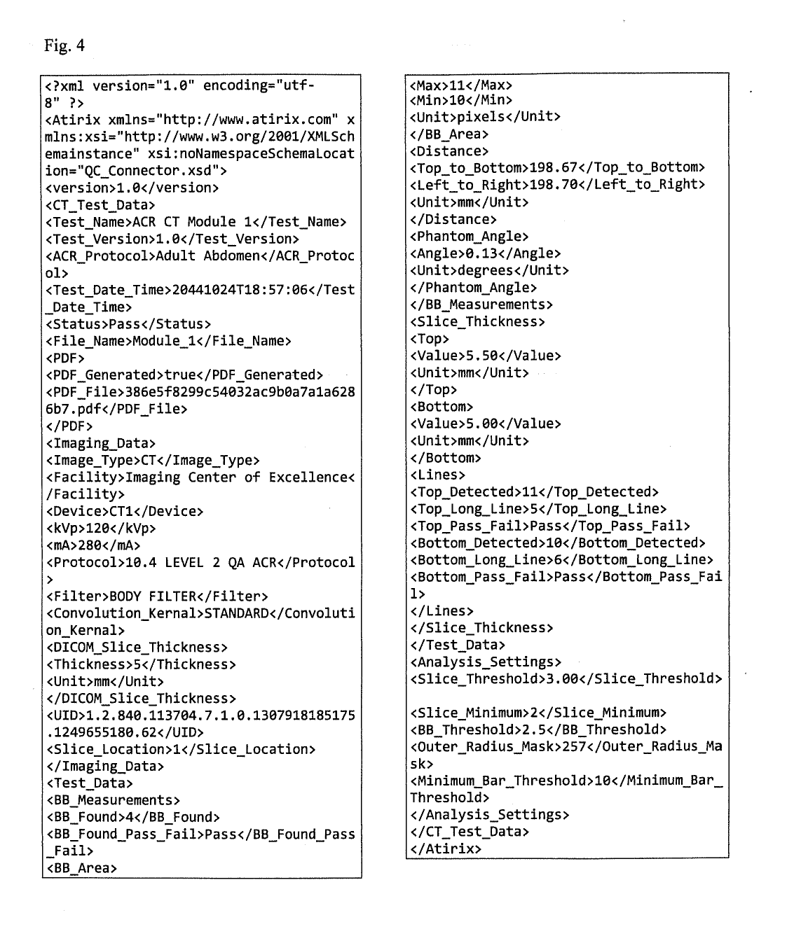

FIG. 4 displays the contents of an embodiment of a quality control data file in a structured format and, in particular, in XML file format. The quality control data file contains quality control data produced by a CT imaging device specific software. While the technical implementation of mapping quality control data is discussed in this section, the use of the quality control interface processing maps to desirably facilitate quality control management and particular applications thereof are discussed in the following two sections. Referring to FIG. 4, for example, if the quality control interface processing software is requested to import quality control data for a quality control test corresponding to the quality control data file represented in the quality control data file, the quality control interface processing software can access the map for the particular quality control test and medical imaging device combination. The quality control interface processing software can then map the quality control data by accessing the corresponding quality control data map, reading the tags in the received quality control data and searching the received quality control data from the quality control data file for the corresponding tagged value. Among the quality control data types the quality control interface processing software can search for in the quality control data file depicted in FIG. 4 is the medical device imaging facility at which the quality control test was performed. The corresponding tag in the quality control data map is “<Institution>” and the quality control interface processing software can then locate the tagged value “Univ. of Va. Hospital 02” and pass that value back to the quality control management software or write that value as part of a quality control data file in a format readable by the quality control management software.

The quality control interface processing maps can be set-up using a variety of approaches. In one embodiment, the quality control interface processing map can be set-up by programming a database. In such an embodiment, the database can comprise a collection of quality control data types expected by the quality control management software and the corresponding locations within the various types of quality control data files. The database can then be accessed by the quality control interface processing software when a user request that quality control data from a specific quality control test be imported into the quality control management software. When such a request is made, the quality control connection software can obtain from the quality control management software a list of quality control data types for a specific quality control test and the quality control connection software, and given the location of the quality control data file, can obtain the request data from a quality control data file by using the location information provided in the programmed database. The located information (i.e. the quality control data) can then be exported to the quality control management software by passing the quality control data to the quality control management software or by writing it as part of worksheet data file readable by the quality control management software.

In one embodiment where the quality control data file is an image file, a separate software component can implement an optical character recognition (“OCR”) process to process the quality control data file and write a structured data file with the quality control data. The structured data file can then be imported into the quality control management software as described above. In embodiments where a separate software component is used to implement an OCR process, the separate software can be caused to be executed by the quality control management software, the quality control interface processing software, or a user. In some embodiments, a service such as, for example, a .Net DLL on a Microsoft Windows® system or a script on a Linux system, can be used to process the images with OCR. In one embodiment, where a user causes a separate software process to execute, the separate software process can, automatically cause the quality control interface processing software to execute after the structured data file is written. The quality control interface processing software can then import quality control data contained in the now structured quality control data file as described above.

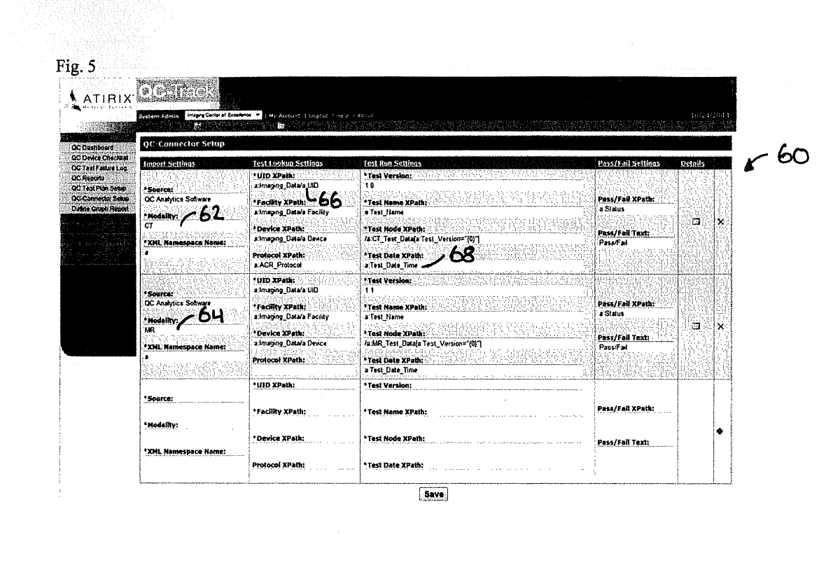

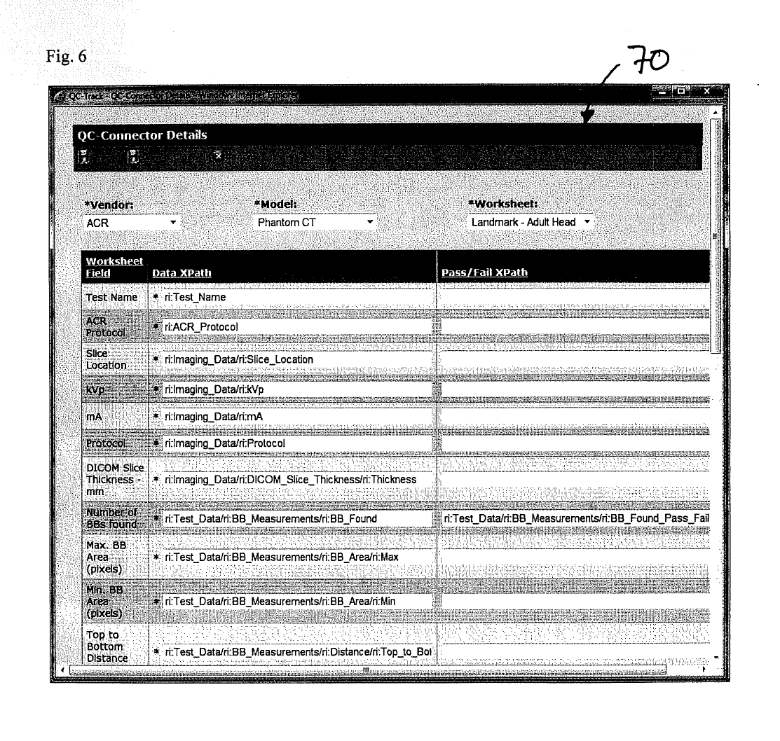

In some embodiments, the quality control interface processing software can provide a user with a particularly efficient method based on a graphical user interface for setting-up quality control interface processing maps. FIG. 5 is a screen shot of one embodiment of a quality control interface processing map set-up screen implemented to populate worksheet template data fields as described above. GUI 60 displays data fields corresponding to data expected by the quality control management software during the mapping of the quality control data from the quality control data file. In the particular embodiment depicted in FIG. 5, the quality control data to be imported is from a quality control data file in XML format. GUI 60 displays map configuration settings for two maps. A first map defines a mapping for quality control data generated by running a first quality control test run on a CT imaging device and a second map defines a mapping for quality control data generated from a second quality control test run on a MR imaging device, as indicated by modality data fields 62, 64, respectively. The values in the data fields indicate the location of the corresponding quality control data in the quality control data file. For example, with respect to the CT quality control data mapping, the location of the user ID of the user who ran the quality control test is identified in data field 66 as “ri:Imaging_Data/ri:UID” and the location of the date on which the quality control was run is identified in data field 68 as “ri:Test_Date_Time.” The icon under the column “Details” allows a user, such as IT support staff, to access further details specific to the particular quality control test. Clicking the icon under the “Details” column corresponding to the CT quality control test brings up a second GUI 70, as shown in FIG. 6. As seen in FIG. 6, relative to GUI 60, GUI 70 provides more specific details relating to the CT quality control test. A user can enter the location of the corresponding data in the quality control data file. The user can then save the quality control data map which is then stored in a data file by itself or in a data file containing other maps.

While, any user can be provided access the software component used to generate a map, in some embodiments, it can be desirable to limit access to a few groups of users. Because the quality control interface processing maps are specified through system design, and because map set-up generally requires detailed technical knowledge of the quality control data file format output by the software specific to a medical device, users such as, for example, medical imaging technicians, physicians, and other medical imaging staff generally do not have and/or need the ability to modify and/or create quality control interface processing maps. Therefore, in such embodiments, it can be desirable to limit the ability of users to create and/or modify maps to technical support users and/or administrators of the quality control interface processing software.

### Quality Control Management

As discussed above, the quality control management software centrally manages quality control data generated from one or more medical imaging devices. The quality control management software can comprise various components to capture and record quality control data, schedule quality control tests, and create reports or collections of reports for audits and on-going monitoring. The various components can comprise, for example, a quality control dashboard, worksheets and worksheet templates, a schedule management module, and/or a reporting module. A quality control management software implementing these components is further described in co-pending U.S. patent application Ser. No. 11/335,858 to Hahn et al., entitled “Mammography Operational Management System and Method,” incorporated herein by reference, and U.S. provisional patent applications 60/742,668 filed on Dec. 6, 2005 and 60/613,054 filed on Jan. 19, 2005, from which the '858 application claims priority and both of which are incorporated herein by reference. An effective quality control management software comprising the above recited features is currently commercially available from Atirix® Medical Systems (Minneapolis, Minn.) and is sold under the name QC-Track®. QC-Track® can be desirably and efficiently implemented as the quality control management software as described herein.

As a part of implementing quality control management, FIG. 7 is screen shot of a quality control device test plan set-up screen. The device test plan set-up screen allows a user to select various quality control tests to be performed on specific vendor/model combination of a medical imaging device, as explained above. A quality control test may be a as simple as indicating that the quality control test was complete, it may also include user-defined data field to record various test metrics, which can be a portion of the full test metrics associated with the particular test. The quality control test plan can be applied to a plurality of imaging devices being managed that match the specific vendor/model combination. Referring to FIG. 7, a user can indicate that a test is started on a specific date and set a recommended occurrence frequency, and the user may define worksheet templates to allow the capture of the specified field values for each test. In general, medical imaging device specific software can define its own quality control test schedule for the medical imaging device to which it is specific.

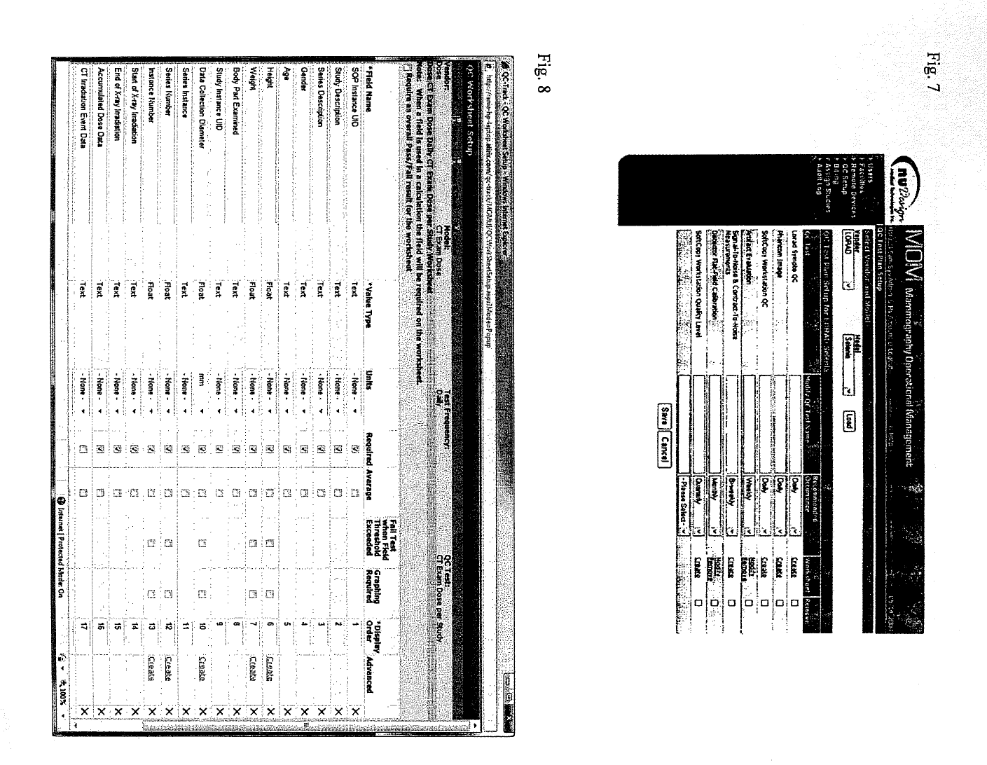

As explained above, a worksheet template is a set of one or more ordered data fields defined by a user, for example, using the set-up screen described above. The data fields may be simple data entry fields or formula calculations. A calculation formula typically includes two operands and an operator. The operand is either a constant value or a reference to the value of another field. The data fields may also be configured to receive text data including, but not limited to, note and comments regarding the quality control test. FIG. 8 is an example screen shot of a quality control worksheet template set-up screen. A user can define a field name describing the type of quality control data to be entered in the field. A user can also define the data type to be entered into a worksheet template data field, such as text, as well as the units for the quality control data. If a user checks the box “Required”, the quality control management software will not allow a user to save a worksheet template as an instance of a worksheet data file if the corresponding worksheet template data fields are not populated. In this embodiment, if the check box “Fail Test when Field Threshold Exceeded” is checked by the user, when data entered into the corresponding data field exceeds a threshold value, the quality control system designate the quality control test as “Failed” when the user chooses to “Calculate” the entered values and the entered values are evaluated by the quality control management system. The threshold value can be provided by creating an advanced worksheet template data field. Referring to the embodiment of a worksheet template set-up screen depicted in FIG. 8, clicking the “create” link under the advanced column can allow a user to create a worksheet template data field for an upper and lower threshold value for the corresponding quality control data type, as well as a center line value, or a value between the upper and lower threshold values, for graphing, which can be used for graphing values that are an absolute distance or a percentage distance from the center line value. In another embodiment, a worksheet template set-up screen can comprise a column with a data field into which a user responsible for managing worksheet configuration settings can directly enter a threshold value for the corresponding quality control data type. In another embodiment, the worksheet field names represent the XML field names directly. Special rules can be embedded in the logic of the quality control interface, such as that all underscores in XML tag names be translated to spaces in worksheet field names, and that the pass/fail tag always be named or placed in a known location relative to the test data for that field.

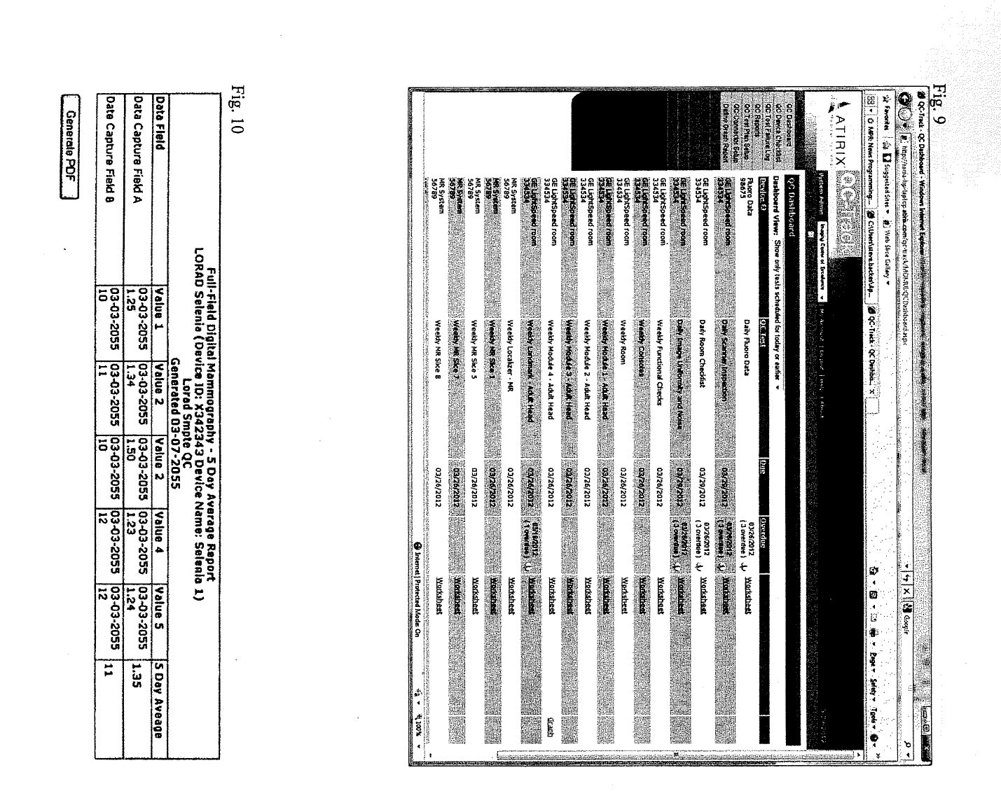

The quality control management software can also display a quality control test dashboard. FIG. 9 is a screen shot of an embodiment of a quality control dashboard. Referring to FIG. 9, the quality control dashboard displays a list of all of the managed medical imaging devices that have a quality control test due date that is on the display date, or that is from a previous day which has not yet been completed. In this embodiment, the quality control test dashboard lists the device, the corresponding test and date the corresponding test is due. The dashboard can show the quality control status of devices in the facility. Any or all of the quality control tests that have a due date that is in the past can be emphasized in the quality control dashboard (e.g. by bold font and/or by colored font) to bring the deficiency to a user's attention. Due dates can be calculated by reviewing each medical imaging device at the selected facility and comparing the quality control tests for the medical imaging device's vendor/model combination with the quality control test schedule set for the specific device. If a quality control test is not associated with a worksheet template, the user can select a “Today” checkbox if they performed the test today, or optional entry of a different date. A quality control test that is associated with a worksheet can provide a link to the corresponding worksheet. Clicking the Worksheet link can open the QC Worksheet screen in a popup. Pressing the Calculate button causes the worksheet to be processed and messages presented to the user on whether the QC test passed or failed. The user has the opportunity to review the data, correct any data entry mistakes, and press Calculate again. Once the data is confirmed to be accurate, the user can press the Record Results button and save all entered dates and comments. In addition, the current user identification can be stored as the user that completed the test. The screen can then be updated upon entry of the information. Pressing the Cancel button prior to saving the data can clear the screen of all data. All of the data entry actions are recorded in an audit log. In another embodiment, the dashboard can show the status of the quality control and credential tracking processes in more than one facility, or at various levels in the organization, such as by imaging department, or in individual hospitals if the organization is a collection or network of hospitals. The status of the individual facilities can be indicated by visual cues on the display screen, such as an icon or a color indicator. If there are items of concern indicated by the status indicators, a drill-down capability can be available to allow the user to navigate the organization's hierarchy and access the dashboard of the individual facility and review the status in more detail.

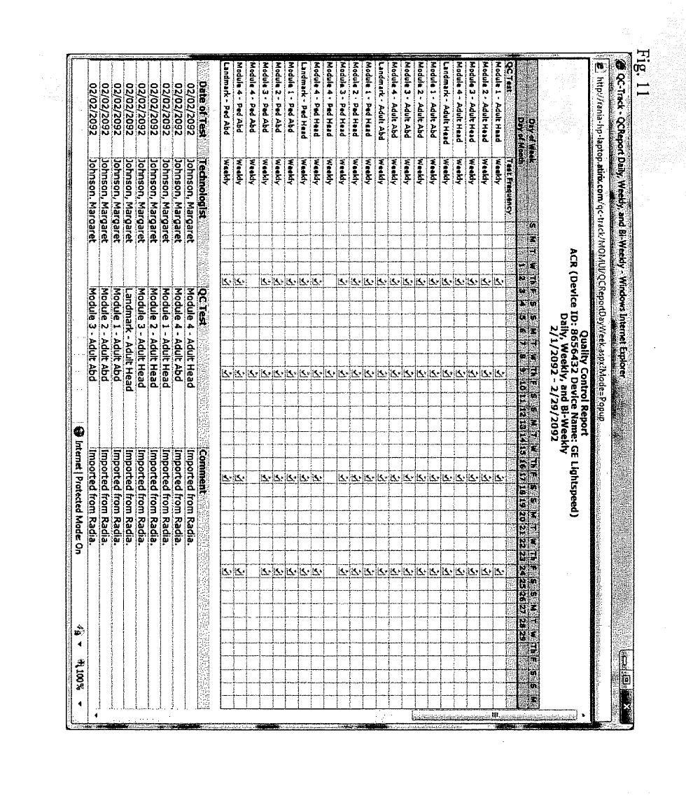

The quality control management software can also define and generate graphic and/or non-graphic reports that convey the requested fields. In some embodiments, to define a report, a user can select a vendor, which causes the vendor's model list box to populate with the defined models for the selected vendor. When the user selects a vendor, the system then populates the worksheet list box with all of the worksheets that are defined for the vendor/model combination quality control test plan. The user can then select the desired worksheet from the worksheet list box and presses a load button, which causes a graph report section to be displayed which allows the user to select report options and fields to graph and/or on which to perform statistical analyses. FIG. 10 is a screen shot of an embodiment of a non-graphic report. In this embodiment, FIG. 10 displays a 5 day, average report for a medical imaging device. “Data Capture Field A” and “Data Capture Field B” correspond to quality control data captured in fields A and B, respectively, in a worksheet template for the corresponding quality control test. The report lists the value of the captured data filed as well as the date the value was captured. The report also lists the average of the captured values over a range of dates. By clicking the “Generate PDF” button, the quality control management software can export the report in a PDF. FIG. 11 is a screen shot another embodiment of a non-graphic report. In this embodiment, FIG. 11 displays a weekly quality control report. The weekly quality control reports display a list of quality control tests that are to be run on a specific medical imaging device (in this embodiment, a medical imaging device having the ID 865432). The columns display the days of the week and indicate whether the corresponding quality control test was run on the medical imaging device. If the corresponding quality control test was run, a check-mark can be placed in the column with the appropriate date. Below, the weekly quality control report displays the date of each lest, the technologist who ran the test, the name of test, and comments, in this embodiment, indicating that the quality control data came from the medical device specific software, which in this embodiment corresponded to “Radia” (i.e., Radia™ software from Radiological Imaging Technology, Inc., Colorado Springs, Colo.) and that the data was “imported” into the quality control management software by way of the quality control interface processing software.

In some embodiments, the centralized quality management can monitor the status of quality control tests, including tests that could be performed continuously between every use of the device, and limit access to an imaging device that has failed its QC, automatically schedule service for the failing unit, automatically notify radiation safety management that the unit is down, and schedule a medical physicist to re-calibrate the device for operation. In another embodiment, the quality control data for an imaging device can be automatically analyzed, and if a trend is identified that may indicate a coming operational failure, service can be scheduled prior to the failure of the imaging system.

In some embodiments, the quality control interface processing software can be an optional component of quality control management software or a stand alone software product. The quality control software can be distributed by a distributor through any convenient means, such as through a download over a network or the like, through enabling dormant functionality upon providing an appropriate command, through distribution of a suitable portable memory device and/or through providing access to a central server or the like having the software. Regardless of the means of providing the software functionalities, ultimately a distributor provides access to an established user of the quality control software.

### Device Specific Quality Control Evaluations

As mentioned above, the quality control system described herein can perform a variety of device specific quality control evaluations. Two specific embodiments of device data files for transfer over a connector program are discussed in the following. Additional embodiments follow similarly.

In one embodiment, the quality control system desirably evaluates CT exam dose data across a plurality of CT imaging devices being managed by the quality control management software. The American College of Radiology (“ACR”) created the National Radiology Data Registry (NRDR) for benchmarking exam-level CT data and diagnostic imaging center are encouraged to submit their CT data to the registry. In one embodiment, the quality control system can extract CT exam dose data from exam-level DICOM records, imported into the quality control management software via the quality control interface processing software, and stored in a quality control management software accessible format. In such an embodiment, it can be particularly desirable for the quality control management software to serve as a hospital system-wide repository, enabling facility management to monitor CT exam dose data across CT equipment. On a periodic basis, the hospital would be able to use the quality control management system to analyze and/or extract CT dose data from the CT does data files and generate a submission to the NRDR. In another embodiment, the CT exam dose data could be monitored across CT equipment, and an alert or visual indicator could be displayed on a quality control dashboard if a CT system is determined to be delivering dose data that is outside of pre-determined thresholds.

In one embodiment, CT exam dose data can be stored in a quality control management software accessible format using the following procedure. After a CT exam on a patient, a CT technologist can take a screen snapshot the CT system console and store the console image as a DICOM image in a PACS system. The console image can contain quality control data, including date, time, patient ID, patient physical characteristics, procedure type, image series type, and delivered radiation dose during the CT procedure. From the PACS the console images are identified and copied via a query, then copied to a file system directory. The quality control data can then be extracted from the CT system consol image using OCR, as described in detail above, and subsequently or concurrently imported into the quality control interface processing software. The exam level CT data is stored by the quality control management software as a worksheet data file. The quality control management software can then generate reports on the stored worksheet data that, for example, compare radiation doses across CT systems, between facilities, for a CT system over time, or by types of procedure on a CT system. A report of the detailed data over a time period can be generated for submission to the NRDR.

Similarly, quality control management and connector software can be used in any number of similar data gathering and aggregation activities in the imaging center that can provide structured data that can be tagged with XML tags, or in any other structured format such as comma separated values. The quality control interface processing software can gather dose data and other exam metrics from any imaging modality, such as fluoroscopy systems (as required by State of Ohio regulations, for example) or for specific types of CT exams, such as data for the ACR's CT Colonoscopy dose repository. Likewise, quality control related tracking data can be captured and stored from RF tags or bar codes used for lead apron tracking or other types of safety product or materials tracking required or recommended by regulating authorities such as The Joint Commission. In addition, service record data or procedure manual data could be gathered and uploaded into the quality control management software via the quality control interface processing software.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A method for managing quality control for a plurality of medical imaging devices using a computer system comprising appropriate software and non-volatile memory, the method comprising:
receiving a data file relating to quality control test data for a medical imaging device;
automatically identifying data from the received quality control test data, the identified data comprising a unique identifier for the medical imaging device, identity of one or more quality control tests run on the medical imaging device, a date on which each of the one or more types of quality control tests were run, and test data corresponding to each of the one or more quality control tests run;
storing the identified data in non-volatile data storage comprising other medical imaging device quality control test data.

2. The method of claim 1 wherein the one or more quality control tests comprises a plurality of similar test run on a plurality of dates and wherein the method further comprises:
displaying the unique identifier for the medical imaging device, at least one of the one or more types of quality control tests, at least one date of the date or dates on which the at least one of the one or more types of quality control tests were run;
requesting a user to indicate one of the plurality of scheduled dates that is satisfied by the at least one date of the dates or dates on which the at least one of the one or more types of quality control tests were run;
and storing the indicated one of the plurality of scheduled dates along with the received quality control test data.

3. The method of claim 1 wherein the unique identifier comprises the name of a medical imaging facility corresponding to the physical location of the medical imaging device and a device identifier for the medical imaging device.

4. The method of claim 1 wherein the identified data further comprises a user identification for each date or dates on which each of the one or more types of quality control tests were run, wherein each user identification specifies a user that ran each of the one or more types of quality control tests on each date or dates.

5. The method of claim 1 wherein the receiving quality control test data comprises receiving the quality control test data from one data file.

6. The method of claim 1 wherein the receiving quality control test data comprising receiving the quality control test data from a plurality of data files.

7. A non-volatile computer memory device storing computer software designed to perform the method of claim 1.

8. A method for distributing medical imaging quality control software, the method comprising distributing software to a customer for execution on a computer, wherein the executing software implements a method comprising:
receiving a data file relating to quality control test data for a medical imaging device;
automatically identifying data from the received quality control test data, the identified data comprising a unique identifier for the medical imaging device, identity of one or more quality control tests run on the medical imaging device, a date on which each of the one or more types of quality control tests were run, and test data corresponding to each of the one or more quality control tests run;
storing the identified data in non-volatile data storage comprising other medical imaging device quality control test data.

9. The method of claim 8 wherein the one or more quality control tests comprises a plurality of similar test run on a plurality of dates and wherein the method implemented by the software further comprises:
displaying the unique identifier for the medical imaging device, at least one of the one or more types of quality control tests, at least one date of the date or dates on which the at least one of the one or more types of quality control tests were run;
requesting a user to indicate one of the plurality of scheduled dates that is satisfied by the at least one date of the dates or dates on which the at least one of the one or more types of quality control tests were run;
and storing the indicated one of the plurality of scheduled dates along with the received quality control test data.

10. A method for managing quality control for a plurality of medical imaging devices using a software program executed with a computer with access to suitable dynamic memory and non-volatile memory, the method comprising:
entering information through a display interface to establish a program to map quality control test data from a medical imaging device to a quality control worksheet format such that the map provides for automatically identifying data from a quality control test data file generated by the medical imaging device, the identified data comprising a unique identifier for the medical imaging device, identity of one or more quality control tests run on the medical imaging device, a date on which each of the one or more types of quality control tests were run, and test data corresponding to each of the one or more quality control tests run.

11. The method of claim 10 wherein the display interface is a software component integrated with a medical device quality control management software comprising software modules that provide graphical display worksheets to facilitate management of a particular quality control test on a particular medical imaging device and wherein the worksheet format interfaced with the mapping function is compatible with the quality control management software functionality.

12. A method for distributing medical imaging quality control software, the method comprising distributing software to a customer for execution of the method of claim 10 on a computer.

13. A non-volatile computer memory device storing computer software designed to perform the method of claim 10.

14. A quality control system for managing the quality control of a plurality of medical imaging devices comprising:
a first software module on a non-volatile memory device accessible by a computer integrated with a medical imaging device to control the operation of the medical imaging device and at least one quality control operations of the medical imaging device; and
a second software module on a non-volatile memory device accessible by a networked computer configured to receive test data from a plurality of medical imaging devices each associated with a first software module, wherein the second software module generates a report based on the test data from the first software module.

15. The quality control system of claim 14 wherein the first software module generates a data file comprising a unique identifier for a medical imaging device, identity of one or more quality control tests run on the medical imaging device, a date on which each of the one or more types of quality control tests were run, and test data corresponding to each of the one or more quality control tests run.

16. The quality control system of claim 14 wherein the second software module comprises a routine to map quality control test data from a medical imaging device to a quality control worksheet format such that the map provides for automatically identifying data from a quality control test data file generated by the medical imaging device, the identified data comprising a unique identifier for the medical imaging device, identity of one or more quality control tests run on the medical imaging device, a date on which each of the one or more types of quality control tests were run, and test data corresponding to each of the one or more quality control tests run.

17. The quality control system of claim 16 wherein the second software module further comprises a routine to control management of quality control information from a plurality of medical imaging devices through a display dashboard that guides a user to quality control schedules relating to the plurality of medial imaging devices.

18. A method for distributing medical imaging quality control software, the method comprising facilitating the establishment of the quality control system of claim 14 by distributing software to a non-volatile, computer readable memory device corresponding to the second software module to a customer having access to data files from the first software module.

19. A method for establishing a medial imaging quality control system of claim 14, the method comprising: programming a second software module specifically to interface with a first software module; and storing the second software module on a non-volatile computer readable memory device.
